(19) United States
(12) Patent Application Publication
(10) Pub. No.: US 2004/0238488 A1
(43) Pub. Date: Dec. 2, 2004

(54) Wafer edge etching apparatus and method

(76) Inventors: Chang Won Choi, Seoul (KR); Jong Baum Kim, Yongin-Si (KR); Tae Ryong Kim, Suwon (KR); Jung-Woo Seo, Suwon (KR); Chang Ju Byun, Youngin-Si (KR)

Correspondence Address: HARNESS, DICKEY & PIERCE, P.L.C., P.O. BOX 8910, RESTON, VA, 20195, US

(21) Appl. No.: 10/762,526

(22) Filed: Jan. 23, 2004

(30) Foreign Application Priority Data
May 27, 2003 (KR) 2003-33844

(51) Int. Cl. C23F 1/00; B44C 1/22; C03C 15/00; C03C 25/68

(52) U.S. Cl. 216/58

(57) ABSTRACT

A wafer edge etching apparatus and method for etching an edge of a semiconductor wafer including a bottom electrode, arranged below the semiconductor wafer and acting as a stage to support the semiconductor wafer. A method of etching a semiconductor wafer including inserting a semiconductor wafer into a chamber, increasing a pressure in the chamber, supplying at least one etchant gas to the chamber while further increasing the pressure, supplying power to the chamber and etching the semiconductor wafer at the edge bead or the backside of the semiconductor wafer, discontinuing the power and the etchant gas, venting the chamber with a venting gas, and purging the venting gas from the chamber.

### BACKGROUND OF THE INVENTION

This U.S. nonprovisional application claims priority under 35 U.S.C. §119 to Korean Patent Application No. 2003-33844 filed May 27, 2003, the contents of which are incorporated by reference in its entirety.

Wafer edge etching is performed to remove thin film layers on a peripheral area of a wafer. The peripheral area of the wafer is often referred to as an edge bead. The edge bead of a wafer is etched because the thin film layers on the edge can cause defects on the chips during the manufacturing process and reduce yield. Thin film layers may be removed from the edge by either a wet or dry etching method. Due to the reduction in chip scale, the need to etch the edge has become more significant.

Conventional devices exist to etch the thin film layers at the edge bead. However, in conventional devices, the plasma generated by such devices is too weak to etch the thin film layer at the edge bead. One solution to this problem is to increase power. However, increased power may warp the wafer.

### SUMMARY OF THE INVENTION

In exemplary embodiments, the present invention is directed to an apparatus for etching an edge of a semiconductor wafer, which includes a bottom electrode, arranged below the semiconductor wafer and acting as a stage to support the semiconductor wafer.

In exemplary embodiments, the present invention is directed to a method of etching a semiconductor wafer, which includes inserting a semiconductor wafer into a chamber; increasing a pressure in the chamber, supplying at least one etchant gas to the chamber while further increasing the pressure; supplying power to the chamber and etching the semiconductor wafer at the edge bead or the backside of the semiconductor wafer, discontinuing the power and the etchant gas, venting the chamber with a venting gas, and purging the venting gas from the chamber.

In exemplary embodiments, the present invention is directed to a method of etching a semiconductor wafer, which includes arranging a bottom electrode below the semiconductor wafer acting as a stage to support the semiconductor wafer, etching the semiconductor wafer at the edge bead or the backside of the semiconductor wafer, and maintaining a gap between the semiconductor wafer and an insulating plate from 0.2 to about 1.0 mm.

In exemplary embodiments, the present invention is directed to a method of etching a semiconductor wafer, which includes arranging an insulating plate, including a protrusion, above the semiconductor wafer, etching the semiconductor wafer at the edge bead or the backside of the semiconductor wafer, and maintaining a gap between the semiconductor wafer and the insulating plate from 0.2 to about 1.0 mm.

In exemplary embodiments, the present invention is directed to a method of etching a semiconductor wafer, which includes arranging a bottom electrode below the semiconductor wafer, the bottom electrode including a plurality of open grooves, and etching the semiconductor wafer at the edge bead or the backside of the semiconductor wafer.

In exemplary embodiments, the present invention is directed to an insulating plate, which includes a body, made of an insulating material and a protrusion, including a sloped surface and a cliff surface.

### BRIEF DESCRIPTION OF THE DRAWINGS

FIG. 1 illustrates an apparatus 100 in accordance with an exemplary embodiment of the present invention.

FIG. 2 illustrates an exemplary portion of the apparatus of FIG. 1 in more detail.

FIG. 3 illustrates an exemplary protrusion of FIG. 2 in more detail.

FIG. 4A illustrates the bottom electrode and stage of FIG. 1 in an exemplary embodiment of the present invention.

FIG. 4B illustrates a schematic view of an upper electrode and an insulating plate in an exemplary embodiment of the present invention.

FIG. 4C illustrates a plan view of a bottom electrode and stage and an edge electrode, in an exemplary embodiment of the present invention.

FIG. 5 illustrates an exemplary relationship between a bottom electrode and stage, an isolator and/or insulator, a wafer, and an edge electrode, in one exemplary embodiment of the present invention.

FIG. 6 illustrates an apparatus in accordance with another exemplary embodiment of the present invention.

FIG. 7 illustrates an apparatus in accordance with another exemplary embodiment of the present invention.

FIG. 8 illustrates a method in accordance with an exemplary embodiment of the present invention.

FIG. 9 illustrates an exaggerated exemplary wafer, after an etching process, such as the exemplary process of FIG. 8.

FIGS. 10A and 10B illustrate a cell region and an edge region, respectively, of a resultant wafer, in accordance with an exemplary embodiment of the present invention.

FIG. 11 illustrates exemplary process conditions which may be used to etch the wafer 1 in accordance with exemplary embodiments of the present invention.

FIGS. 12A-C illustrate experimental results showing the relationship between etch rates of various oxides on a wafer, in accordance with exemplary embodiments of the present invention.

FIG. 13 illustrates a plot of the length from the endpoint of a wafer versus the gap between the insulating plate and the upper electrode in exemplary embodiments of the present invention.

FIG. 14 illustrate varying gaps in accordance with exemplary embodiments of the present invention.

FIG. 15 illustrates a cross-sectional view of a plasma processing apparatus for processing the edge of a wafer in accordance with an exemplary embodiment of the present invention.

### DETAILED DESCRIPTION OF THE EXEMPLARY EMBODIMENTS

The present invention will become more fully understood from the detailed description given below and the accompanying drawings, which are given for purposes of illustration only, and thus do not limit the invention.

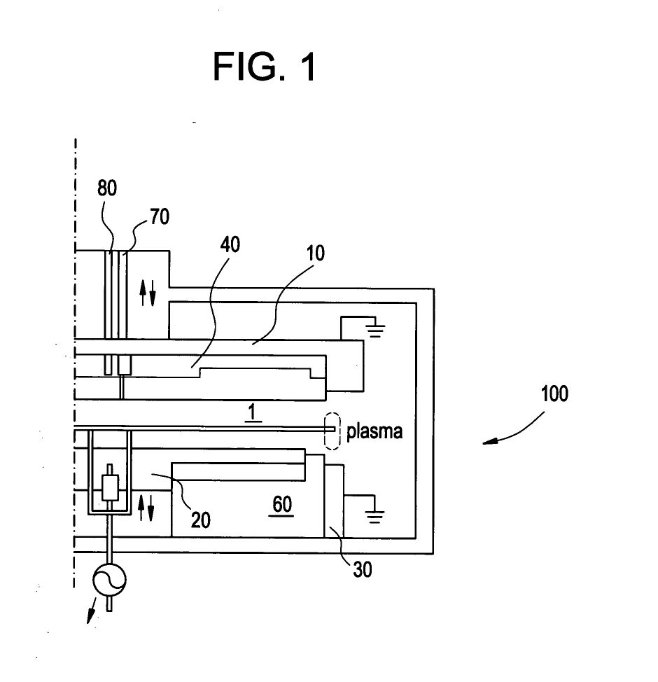

FIG. 1 illustrates an apparatus 100 in accordance with an exemplary embodiment of the present invention. The apparatus 100 includes an upper electrode 10, a bottom electrode and stage 20, an edge electrode 30, and insulating plate 40, an RF power supply 50, an isolator and/or insulator 60, a center nozzle 70, and a process nozzle 80. In the apparatus 100 as shown in FIG. 1, the upper electrode 10 and the edge electrode 30 are anodes and the bottom electrode 20 is a cathode. However, each of these may be reversed in other exemplary embodiments of the present invention. As shown in FIG. 1, the bottom electrode 20 supports the wafer 1 while the upper electrode 10 and the edge electrode 30 reciprocally generate plasma at an edge and/or a backside of the wafer 1. An etching portion A at the edge of the wafer 1 is where the desired etching should take place. Because RF power is supplied from the RF power line 50 through the wafer 1, a lower power generates sufficiently proper plasma to etch thin film layers on the wafer 1. An example of a lower power is 500 W. If the RF power is high, which is generally used in a normal semiconductor etcher, arcs may be caused at the edge bead.

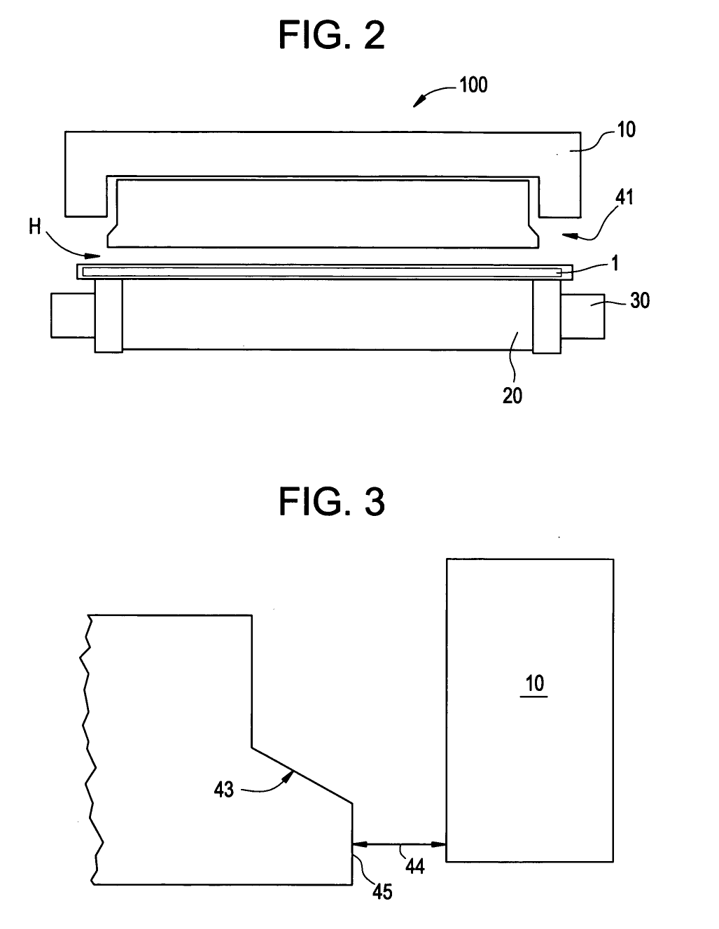

FIG. 2 illustrates an exemplary portion of the apparatus 100 of FIG. 1 in more detail. In particular, FIG. 2 illustrates the upper electrode 10, the bottom electrode 20, the edge electrode 30, the insulating plate 40, and the wafer 1 in more detail. As illustrated in FIG. 2, the insulating plate 40 and the wafer 1 are separated by a variable distance H. As illustrated in FIG. 2, the insulating plate 40 may include a protrusion 41. In an exemplary embodiment, the protrusion 41 has a slope or other contour which guides the processing gas, thereby preventing or substantially preventing the processing gas from flowing onto the center area of the wafer during the etching process. Although the protrusion 41 of FIG. 2 has a particular shape, it is noted that this shape is exemplary, and other shapes, which suitably guide the processing gas away from the center area of the wafer 1 during the etching process may also be utilized.

FIG. 3 illustrates an exemplary protrusion 41 of FIG. 2 in more detail. As shown, the protrusion 41 includes a sloped portion 43, and a cliff 45. The cliff 45 forms a gap 44 with the upper electrode 10. The gap 44 between the protrusion 41 and the upper electrode 10 may be controlled to control the etched area of the wafer 1. In an exemplary embodiment, the gap 44 is uniform or substantially uniform, although this need not be the case. In other exemplary embodiments, the shape of the cliff 45 may be designed to enhance the durability of the cliff 45 and/or the insulating plate 40.

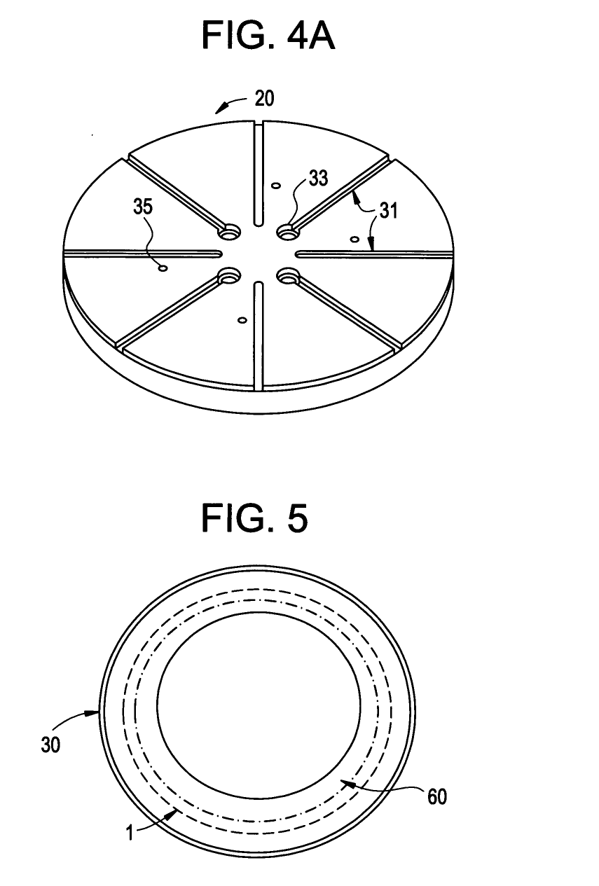

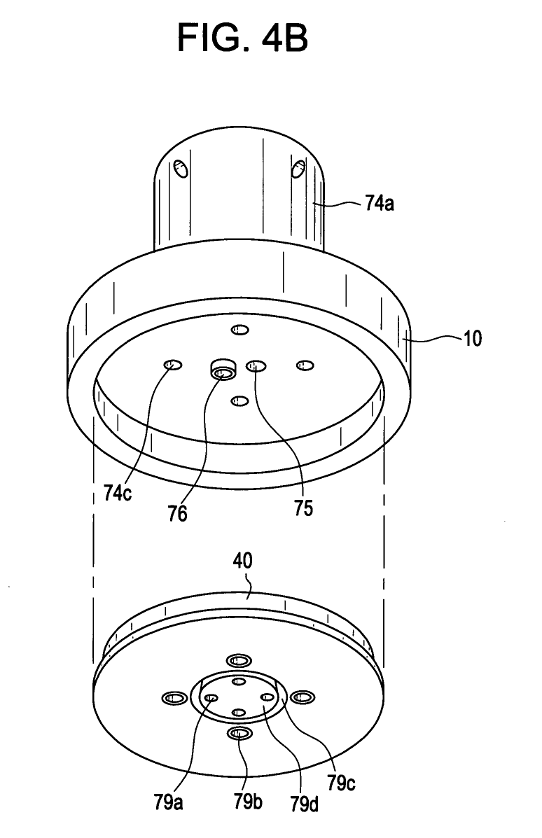

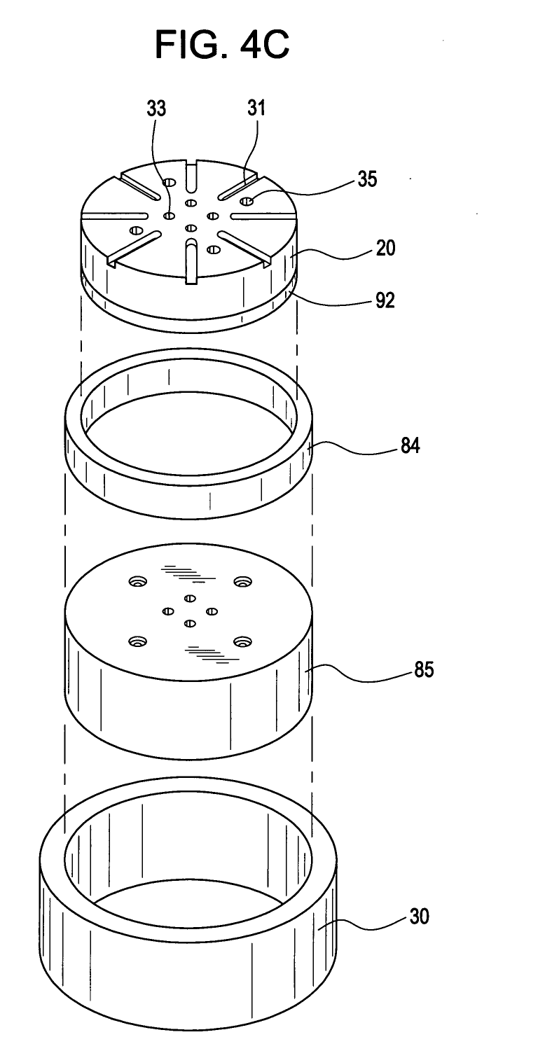

FIG. 4A illustrates the bottom electrode and stage 20 of FIG. 1 in an exemplary embodiment of the present invention. As shown in FIG. 4A, the bottom electrodes 20 includes one or more grooves 31. The one or more groves 31 reduce the likelihood or prevent the wafer 1 from sliding off the bottom electrode and stage 20. As shown in FIG. 4A, the one or more grooves 31 are shown as straight lines radiating from the center of the bottom electrode 20. In other exemplary embodiments, the grooves 31 may be curved lines. In the other exemplary embodiments of the present invention, the straight and/or curved grooves 31 may radiate from other than the center of the bottom electrode 20. In exemplary embodiments of the present invention, the grooves 31 form an open pattern, as opposed to a closed pattern, such as a circle, rectangle, triangle, etc. In exemplary embodiments of the present invention, the bottom electrode and stage 20 may include one or more bolt holes 33 and/or one or more lift pin holes 35.

FIG. 4B illustrates a schematic view of the upper electrode 10 and the insulating plate 40 in an exemplary embodiment of the present invention and FIG. 4C illustrates a plan view of the bottom electrode and stage 20 and the edge electrode 30, in an exemplary embodiment of the present invention.

FIG. 4B illustrates an upper portion where process gas(es) and/or inert gas(es) are distributed. As shown in FIG. 4B, the upper electrode 10 may include one or more sources of process gas 75 and one or more sources of inert gas 76 and be accompanied by an upper electrode support 74a. As also shown in FIG. 4B, the insulating plate 40 may include one or more supplemental gas outlets 79c and one or more supplemental insulating plates 79d.

In exemplary embodiments of the present invention, the upper electrode 10 includes one or more bolt holes 74c, 79b to connect the insulating plate 40 to the upper electrode 10. In other exemplary embodiments of the present invention, the insulating plate 40 includes one or more bolt holes 79a to connect the insulating plate 40 to the one or more supplemental insulating plates 79d.

FIG. 4C illustrates a lower portion where the wafer 1 is loaded. As shown in FIG. 4C, a first insulator 84 (which may be in the shape of a ring) and a second insulator 85 (which may be in the shape of a cylindrical plate) may be utilized between the bottom electrode 20 and the edge electrode 30.

FIG. 5 illustrates the relationship between the bottom electrode and stage 20, the isolator and/or insulator 60, the wafer 1, and the edge electrode 30, in an exemplary embodiment of the present invention.

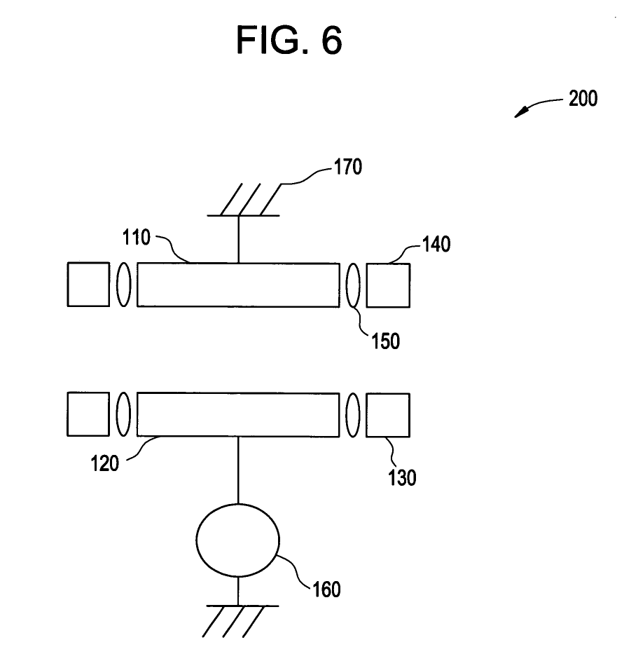

FIG. 6 illustrates an apparatus 200 in accordance with another exemplary embodiment of the present invention. As illustrated in FIG. 6, the apparatus 200 includes an upper electrode 110, and bottom electrode and stage 120, a first edge electrode 130, a second edge electrode 140, an insulator 150, an RF power supply 160, and a ground terminal 170. As illustrated in FIG. 6, the bottom electrode and stage 120 supports the wafer 1 while the upper electrode 110, the first edge electrode 130, and the second edge electrode 140 reciprocally generate plasma at the edge bead and/or backside of the wafer 1. As described above, in conjunction with the embodiment illustrated in FIG. 1, the upper electrode 110, the bottom electrode and stage 120, the first electrode 130, and the second electrode 140 may each be either an anode or a cathode.

In exemplary embodiments, the first edge electrode 130 and/or the second edge electrode 140 are doughnut-shaped electrodes, which focus plasma at the edge bead and/or backside of the wafer 1.

In the exemplary embodiment illustrated in FIG. 6, because the RF power is supplied through the wafer 1, a lower power may be used to generate sufficient plasma to etch thin film layers on the wafer 1. An example of lower power is 500 watts. As described above, a conventional RF power of 2000 watts, may cause arcs at the edge bead.

It is noted that the various exemplary embodiments of the insulating plate illustrated in FIGS. 2 and 4 and/or the various exemplary embodiments of the bottom electrode 20 illustrated in FIGS. 4 and 5 may also be utilized in the exemplary embodiment illustrated in FIG. 6.

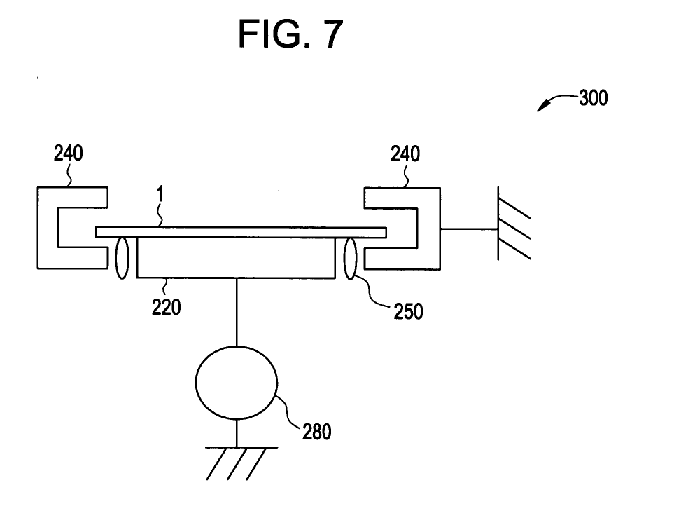

FIG. 7 illustrates an apparatus 300 in accordance with another exemplary embodiment of the present invention. As illustrated, the apparatus 300 includes a bottom electrode and stage 220, an edge electrode 240, an insulator 250, and an RF power supply 280. As illustrated in FIG. 7, the bottom electrode and stage 220 supports the wafer 1. As also illustrated in FIG. 7, the edge electrode 240 is a ring-type edge electrode, which reciprocally generates plasma at the edge bead and/or backside of the wafer 1.

It is noted that the various exemplary embodiments of the insulating plate illustrated in FIGS. 2 and 3 and the various exemplary embodiments of the bottom electrode 20 illustrated in FIGS. 4 and 5, may also be utilized in conjunction with the exemplary embodiment illustrated in FIG. 7.

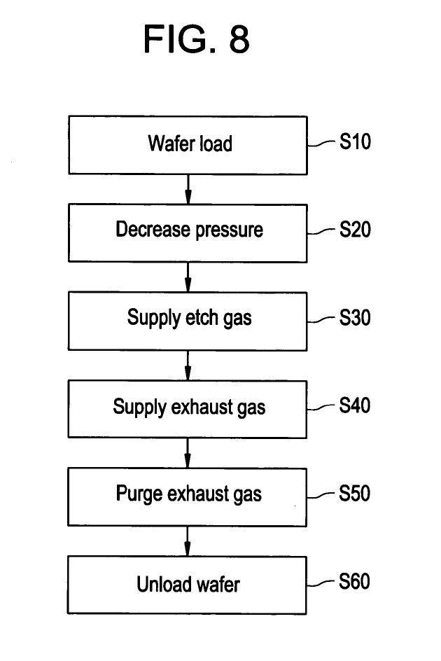

FIG. 8 illustrates an exemplary method in accordance with the present invention. In step S10, the wafer 1 is loaded into a chamber. In step S20, the pressure in the chamber is decreased. In step S30, at least one etching gas is supplied to the chamber while increasing the pressure. In step S30, power is also supplied to the chamber to etch the semiconductor wafer at the edge bead or the backside of the semiconductor wafer. After step S30, supply of the at least etching gas and the end power is ceased and in step S40, an exhaust gas is supplied to the chamber. At step S50, the exhaust gas is purged from the chamber and at step S60, the wafer is unloaded from the chamber.

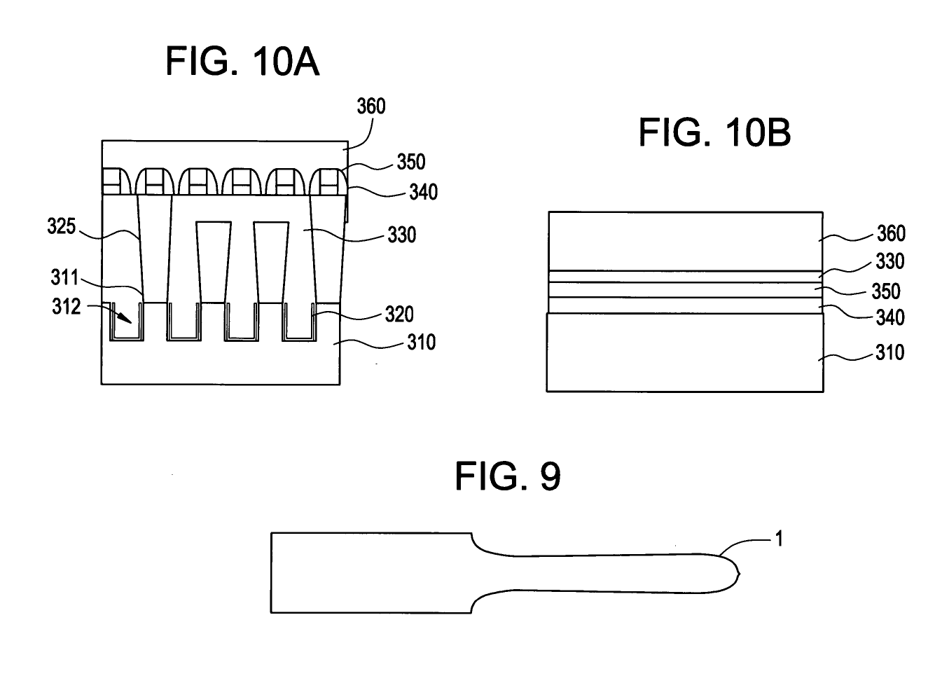

FIG. 9 illustrates an exaggerated example of the wafer 1, after an etching process, such as the exemplary process of FIG. 8. FIGS. 10A and 10B illustrate the cell region and the edge region, respectively of the resultant wafer 1, in accordance with an exemplary embodiment of the present invention. As illustrated in FIG. 10A, the wafer 1 include a silicon substrate 310, a shallow trench isolation layer (STI) layer 320, an insulating layer 330, a tungsten (W) layer 340, a first/second nitride layer 350, and an oxide layer 360. As shown, FIG. 10A illustrates the cell region of a wafer 1 including the silicon substrate 310 with active regions 311 and passive regions 312. The cell region also includes trenches formed by shallow trench isolation (STI) 320. The cell region may also further include a polysilicon layer 325.

The insulating layer 330 may be of a boron-doped phosphosilicate glass (BPSG) or tetraethylorthosilicate (TEOS) of a thickness 3000-8000 Å. The tungsten (W) layer 340 may be formed using WF₆ gas and may have a o thickness of 300 to 1000 Å. The first and second nitride layers 330, 350 may be of a thickness of 1500-3500 Å and 150-750 Å, respectively, and formed using SiH₄+NH₃ gas. The oxide layer 360 may be formed using SiH₄+O₂ gas and of a thickness of 1000-5000 Å.

It is noted that the above thicknesses and materials are exemplary and others may also be used as would be known to one of ordinary skill in the art.

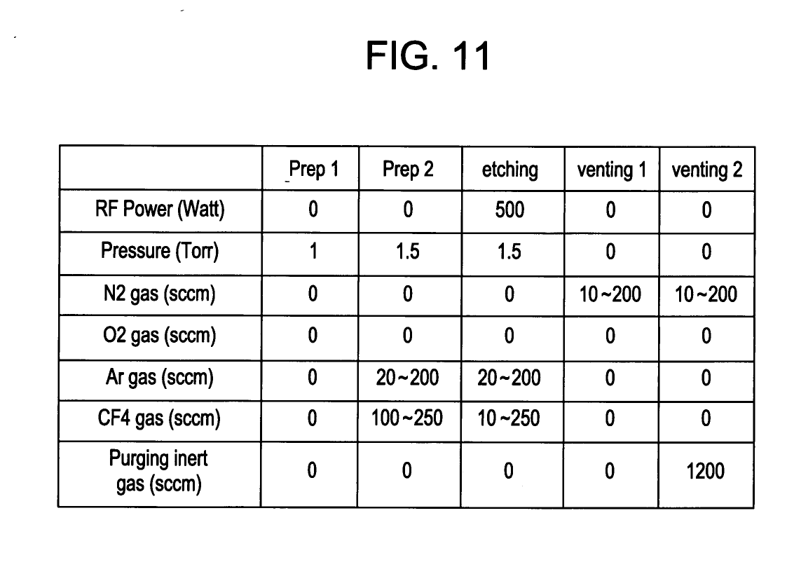

FIG. 11 illustrates exemplary process conditions which may be used to etch a wafer in accordance with exemplary embodiments of present invention. As indicated in FIG. 11, preparing a chamber for etching may be achieved in a two stage process. In the first stage, the pressure is raised, wherein the second preparation stage, the pressure is raised further and one or more etching gases supplied. During the etching step, the pressure is maintained, the supply of the etching gas(es) is maintained, and the RF power is supplied. In the first preparation stage, the pressure may be raised to one Torr. In the second preparation stage, the pressure may be raised to 1.5 Torr, and the etching gases may include argon gas and/or CF₄ gas, supplied in a range of for example, 20-200 sccm for argon gas and 100-250 sccm for CF₄ gas. In an exemplary embodiment, during the etching step, the RF power is raised to 500 watts, the pressure is maintained at 1.5 Torr, and the flows of the etching gas(es) are maintained constant with that of the second preparation stage.

Once the wafer 1 is etched, the chamber may be vented, also in a two stage manner. In the first stage, the power is discontinued, the pressure is returned to normal and a venting gas, such as N₂ gas is supplied. In an exemplary embodiment, the flow of the purging gas is 10-200 sccm. In the second venting step, the venting gas is still supplied, and a purging gas is also supplied. In an exemplary embodiment, the purging gas is an inert gas and is supplied, for example, at a rate of 1200 sccm. In an exemplary embodiment, it is noted that the gas such as the inert gas does not flow through the center nozzle 70 illustrated in FIG. 1, during the edge etching processing, because such a gas may cause an arc in the center portion of the wafer 1.

It is noted that the above powers, gases, pressures and flow rates are exemplary and others may also be used as would be known to one of ordinary skill in the art. It is also noted that the above preparing, etching, and venting steps are exemplary and may be formed in more or fewer steps as would be known to one of ordinary skill in the art.

It is also noted that in exemplary embodiments of the present invention, gas(es), such as inert gas(es), do not flow through the center nozzle 70 during an edge etching process because the gas(es) may cause an arc in the center portion of the substrate.

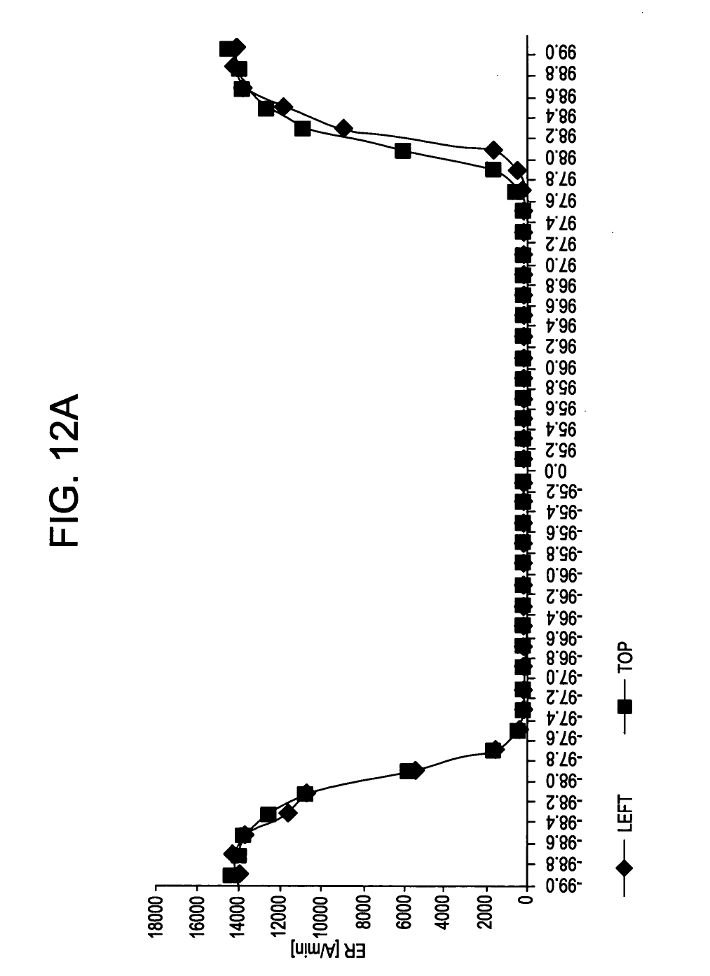

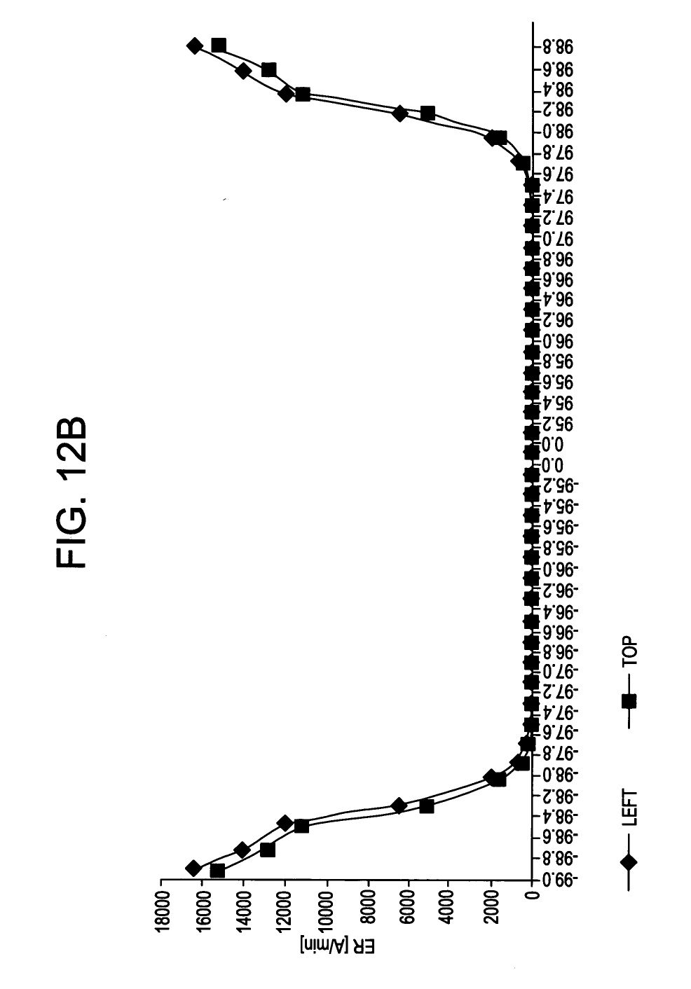

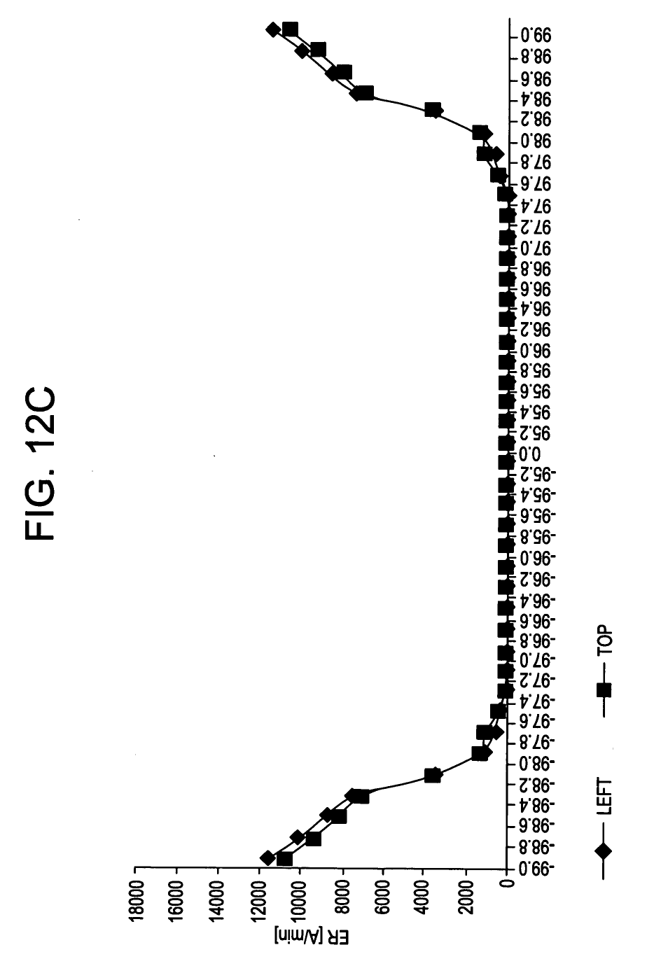

FIGS. 12A-C illustrate experimental results showing the relationship between etch rates of various oxides on a wafer, which show only an edge portion of the wafer etched and a center portion of the wafer is not etched. The conditions under which the results of FIGS. 12A-C were obtained include an RF power of 500 W, a pressure of 1.5 Torr, a process gas of argon gas and CF₄ gas, where the argon gas is supplied at 70 sccm and the CF₄ gas is supplied at 150 sccm, and a gap of 1.5 mm. FIGS. 12A-C illustrate that different material layers have the same or similar etch rates under the same or similar process conditions. As a result, different material layers can be removed in one process step without changing or substantially changing process conditions. This is an advantage over conventional wet-type methods using chemicals, where different chemicals are used to remove different material layers.

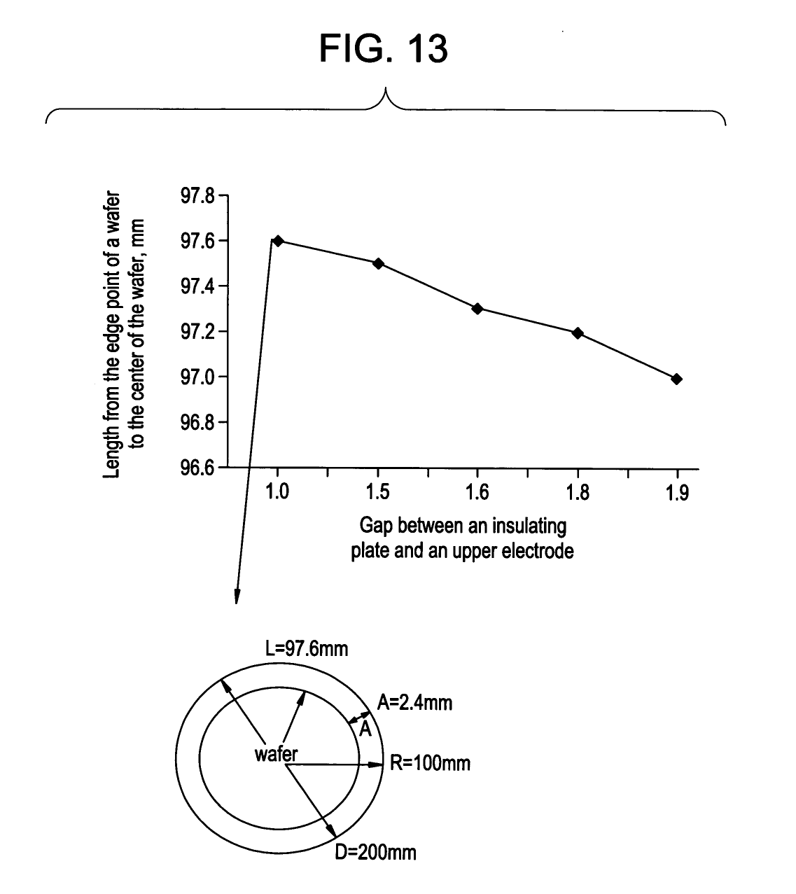

FIG. 13 illustrates a plot of the gap 44 between the insulating plate and the upper electrode (the x-axis) versus the length L from a center of a wafer to the endpoint of the wafer (the y-axis) in exemplary embodiments of the present invention. As shown in FIG. 13, L plus A equals the radius of the wafer 1. For example, the first point in FIG. 13 indicates that an etching portion A of 2.4 mm is produced using a 200 mm diameter wafer (100 mm radius wafer) and a gap 44 of 1.0 mm. As can be seen in FIG. 13, as the gap 44 increases, L decreases (and correspondingly, A increases).

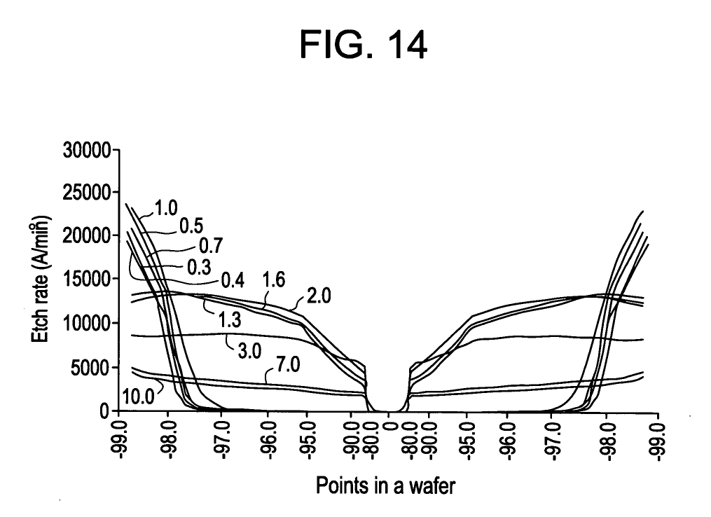

FIG. 14 is a plot of length of the semiconductor substrate (the x-axis) versus etching rate (the y-axis), for a number of different values of H (as shown, between 0.3 and 10.0). As shown, there is a positive correlation between the distance H between the insulating plate 40 and the wafer 1 and the gap 44 between the cliff 45 of the insulating plate 40 and the upper electrode 10. In the exemplary plot of FIG. 14, a gap 44 of 1.6 mm is used and the layer to be etched is an oxide.

FIG. 14 illustrates the data for several different values of H, some of which show better performance (for example, 0.3, 0.4, 0.5, 0.7, and 1.0 millimeters), although distances of H, from 0.3 millimeters to 10.0 millimeters are also feasible in accordance with other exemplary embodiments of the present invention.

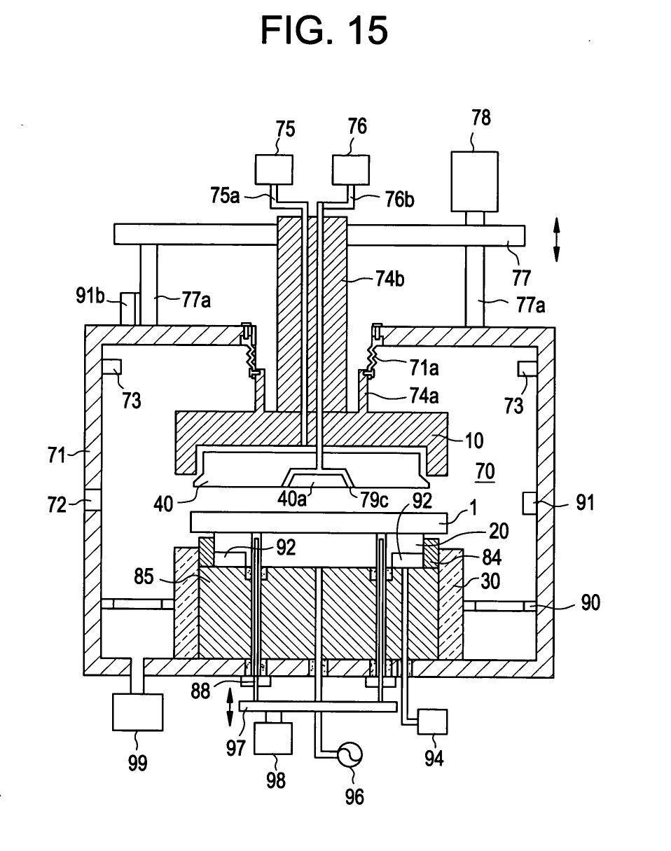

FIG. 15 illustrates a cross-sectional view of a plasma processing apparatus for processing the edge of a wafer in accordance with an exemplary embodiment of the present invention. As shown, the plasma processing apparatus may include a chamber 70, a chamber wall 71, an elastic part 71a, a wafer inlet/outlet 72, a purging gas inlet, an upper electrode 10, a support 74a for the upper electrode 10, a stem 74b, a source of process gas 75, a process gas line 75a, a source of inert gas 76, an inert gas line 76b, a plate 77 of the upper electrode 10, which can move up and down, a support 77a for the plate 77 of the upper electrode 10, a driver 78 for the plate 77 of the upper electrode 10, an insulating plate 40, a supplemental insulating plate 40a, a supplemental gas outlet 79c, a wafer 1, a bottom electrode and stage 20, a first insulator 84, a second insulator 85, an edge electrode 30, a lift pin 88 (to receive and load the wafer 1 on the bottom electrode and stage 20), a baffle plate 90 (to exhaust process gas or inert gas uniformly), a sensor 91, a coolant line 92, a source of coolant 94, an RF power source 96, a lift pin plate 97, a driver 98 for the lift pin plate 97, and an exhaust pump 99.

In an exemplary embodiment, the processing apparatus may include more than one chamber. In exemplary embodiment, the apparatus includes more than one preparing station, more than one process chamber, and more than the one purging chamber, and at least one transfer chamber. In this manner, one wafer may be loaded, while another wafer is being transferred, and yet another wafer is being processed.

As set forth above, in exemplary embodiments, power, such as RF power, is supplied through the wafer, and generates sufficient power to produce plasma to etch thin film layers. It is noted that the power may be supplied through some other layer instead of or in addition to the wafer as would be known to one of ordinary skill in the art. It is further noted that the power may be less than the conventional power of 2000 W, such as the 500 W described in conjunction with on or more of the exemplary embodiments of the present invention.

In an exemplary embodiment, the upper electrode 10 is a solid plate electrode.

In exemplary embodiments of the present invention, the gap is used to control the size and etched area on the semiconductor wafer. In other exemplary embodiments, additional interchangeable insulating plates are used, each arrangeable adjacent to the solid upper electrode and each having a different gap size therebetween. In exemplary embodiments, the gap between the semiconductor wafer and the insulating plate is between 0.2 and about 1.0 mn.

In an exemplary embodiment, O₂ and SF₆ may be utilized as etching gases, either alone or in combination with argon gas and/or CF₄ gas. In an exemplary embodiment, the etching gas etches all desired layers on the semiconductor wafer.

In an exemplary embodiment, the insulating plate is made of an insulating material such as ceramic and/or quartz.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. An apparatus for etching an edge of a semiconductor wafer, comprising:
a bottom electrode, arranged below the semiconductor wafer and acting as a stage to support the semiconductor wafer.

2. The apparatus of claim 1, further comprising:
a solid plate upper electrode, arranged above the semiconductor wafer.

3. The apparatus of claim 1, further comprising:
a ring type upper electrode, arranged above the semiconductor wafer.

4. The apparatus of claim 2, further comprising:
a lower edge electrode, arranged below the semiconductor wafer, where the solid upper electrode and the lower edge electrode reciprocally generate plasma at the edge and a backside of the semiconductor wafer.

5. The apparatus of claim 2, further comprising:
a lower edge electrode, arranged below the semiconductor wafer, where the ring type upper electrode and the lower edge electrode reciprocally generate plasma at the edge and a backside of the semiconductor wafer.

6. The apparatus of claim 4, wherein any of the bottom electrode, the solid upper electrode, and the lower edge electrode is a cathode or an anode.

7. The apparatus of claim 2, further comprising:
an insulating plate, arranged adjacent to the solid upper electrode with a gap therebetween.

8. The apparatus of claim 3, further comprising:
an insulating plate, arranged adjacent to the ring type upper electrode with a gap therebetween.

9. The apparatus of claim 4, further comprising:
an isolator, arranged between the bottom electrode and the lower edge electrode.

10. The apparatus of claim 7, wherein a distance between the insulating plate and the semiconductor wafer is small enough to substantially prevent plasma from being formed in a center area of the semiconductor wafer.

11. The apparatus of claim 10, wherein a distance between the insulating plate and the semiconductor wafer is small enough to substantially prevent plasma from being formed in a center area of the semiconductor wafer.

12. The apparatus of claim 7, wherein the insulating plate includes a protrusion.

13. The apparatus of claim 12, wherein the protrusion includes a sloped surface and a cliff surface, the cliff surface forming a gap with the solid upper electrode.

14. The apparatus of claim 12, the protrusion substantially preventing etchant gas from flowing to a center area of the semiconductor wafer.

15. The apparatus of claim 13, wherein the gap controls the size of an etched area on the semiconductor wafer.

16. The apparatus of claim 7, further comprising:
additional interchangeable insulating plates, each arrangeable adjacent to the solid upper electrode and each having a different size gap therebetween.

17. The apparatus of claim 1, said bottom electrode including a plurality of open grooves.

18. The apparatus of claim 17, wherein the plurality of open grooves are straight or curved.

19. The apparatus of claim 4, further comprising:
an upper edge electrode, arranged above the semiconductor wafer, where the solid upper electrode, the lower edge electrode and the upper edge electrode reciprocally generate plasma at the edge and the backside of the semiconductor wafer.

20. The apparatus of claim 19, wherein any of the bottom electrode, the upper edge electrode, the solid upper electrode, and the lower edge electrode is a cathode or an anode.

21. The apparatus of claim 19, further comprising:
an insulating plate, arranged adjacent to the solid upper electrode with a gap therebetween.

22. The apparatus of claim 21, wherein a distance between the insulating plate and the semiconductor wafer is small enough to substantially prevent plasma from being formed in a center area of the semiconductor wafer.

23. The apparatus of claim 21, wherein the insulating plate includes a protrusion.

24. The apparatus of claim 23, wherein the protrusion includes a sloped surface and a cliff surface, the cliff surface forming a gap with the upper edge electrode.

25. The apparatus of claim 23, the protrusion substantially preventing etchant gas from flowing to a center area of the semiconductor wafer.

26. The apparatus of claim 24, wherein the gap controls the size of an etched area on the semiconductor wafer.

27. The apparatus of claim 21, further comprising:
additional interchangeable insulating plates, each arrangable adjacent to the solid upper electrode and each having a different size gap therebetween.

28. The apparatus of claim 19, said bottom electrode including a plurality of open grooves.

29. The apparatus of claim 28, wherein the plurality of open grooves are straight or curved.

30. The apparatus of claim 1, further comprising:
an edge bead electrode for reciprocally generating plasma at the edge and the backside of the semiconductor wafer.

31. The apparatus of claim 30, further comprising:
an insulating plate, arranged adjacent to the solid upper electrode with a gap therebetween.

32. The apparatus of claim 31, wherein a distance between the insulating plate and the semiconductor wafer is small enough to substantially prevent plasma from being formed in a center area of the semiconductor wafer.

33. The apparatus of claim 32, wherein the insulating plate includes a protrusion.

34. The apparatus of claim 33, wherein the protrusion includes a sloped surface and a cliff surface, the cliff surface forming a gap with the edge bead electrode.

35. The apparatus of claim 33, the protrusion substantially preventing etchant gas from flowing to a center area of the semiconductor wafer.

36. The apparatus of claim 34, wherein the gap controls the size of an etched area on the semiconductor wafer.

37. The apparatus of claim 31, further comprising:
additional interchangeable insulating plates, each arrangeable adjacent to the solid upper electrode and each having a different size gap therebetween.

38. The apparatus of claim 30, said bottom electrode including a plurality of open grooves.

39. The apparatus of claim 38, wherein the plurality of open grooves are straight or curved.

40. A method of etching a semiconductor wafer, comprising:
inserting a semiconductor wafer into a chamber;
increasing a pressure in the chamber;
supplying at least one etchant gas to the chamber while further increasing the pressure;
supplying power to the chamber and etching the semiconductor wafer at the edge bead or the backside of the semiconductor wafer;
discontinuing the power and the etchant gas;
venting the chamber with a venting gas; and
purging the venting gas from the chamber.

41. A method of etching a semiconductor wafer, comprising:
arranging a bottom electrode below the semiconductor wafer acting as a stage to support the semiconductor wafer;
etching the semiconductor wafer at the edge bead or the backside of the semiconductor wafer; and
maintaining a gap between the semiconductor wafer and an insulating plate from 2 to about 1.0 mm.

42. A method of etching a semiconductor wafer, comprising:
arranging an insulating plate, including a protrusion, above the semiconductor wafer;
etching the semiconductor wafer at the edge bead or the backside of the semiconductor wafer; and
maintaining a gap between the semiconductor wafer and the insulating plate from 2 to about 1.0 mm.

43. A method of etching a semiconductor wafer, comprising:
arranging a bottom electrode below the semiconductor wafer, the bottom electrode including a plurality of open grooves; and
etching the semiconductor wafer at the edge bead or the backside of the semiconductor wafer.

44. An insulating plate, comprising:
a body, made of an insulating material; and
a protrusion, including a sloped surface and a cliff surface.
